(19) United States
(12) Patent Application Publication
(10) Pub. No.: US 2023/0309119 A1
(43) Pub. Date: Sep. 28, 2023

(54) TRAFFIC BASED RANDOM RESOURCE SELECTION ON NR SIDELINK

(71) Applicant: Fraunhofer-Gesellschaft zur Förderung der angewandten Forschung e.V., München (DE)

(72) Inventors: Dariush MOHAMMAD SOLEYMANI, Erlangen (DE); Martin LEYH, Erlangen (DE); Elke ROTH-MANDUTZ, Erlangen (DE); Shubhangi BHADAURIA, Erlangen (DE); Mehdi HAROUNABADI, Erlangen (DE); Dietmar LIPKA, Erlangen (DE); Lavanya RAVINCHANDRAN, Erlangen (DE)

(21) Appl. No.: 18/327,767

(22) Filed: Jun. 1, 2023

Related U.S. Application Data
(63) Continuation of application No. PCT/EP2021/084175, filed on Dec. 3, 2021.

(30) Foreign Application Priority Data
Dec. 3, 2020 (EP) 20211701.6

(51) Int. Cl. H04W 72/25; H04W 72/02

(52) U.S. Cl. CPC H04W 72/25; H04W 72/02

(57) ABSTRACT

Embodiments provide a transceiver of a wireless communication system, wherein the transceiver is configured to operate in a sidelink in-coverage, out of coverage or partial coverage scenario, in which resources for a sidelink communication are allocated or scheduled autonomously by the transceiver, wherein the transceiver is configured to perform, for the sidelink communication, a random selection of resources out of a resource pool based on
a traffic density and/or user density on the resource pool, and/or
a type of traffic on the resource pool, and/or
a quality of service.

### CROSS-REFERENCE TO RELATED APPLICATIONS

This application is a continuation of copending International Application No. PCT/EP2021/084175, filed Dec. 3, 2021, which is incorporated herein by reference in its entirety, and additionally claims priority from European Application No. 20211701.6, filed Dec. 3, 2020, which is also incorporated herein by reference in its entirety.

### TECHNICAL FIELD

Embodiments of the present application relate to the field of wireless communication, and more specifically, to resource selection in sidelink operation. Some embodiments relate to a traffic based random resource selection on NR (NR=new radio) sidelink.

### BACKGROUND OF THE INVENTION

FIG. 1 is a schematic representation of an example of a terrestrial wireless network 100 including, as is shown in FIG. 1(a), a core network 102 and one or more radio access networks RAN1, RAN2, . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device.

The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In LTE V2X Mode 4 [1] and NR V2X Mode 2, the following radio resource selection procedures are undertaken: (1) random radio resource selection, (2) partial sensing, and (3) sensing-based radio resource selection.

If the random radio resource selection is configured by higher layer signaling, an user transmits on a single carrier within a resource pool of a carrier, which is configured by the base station (e.g., eNB/gNB). A set of radio resources is selected and sent to a higher layer, wherein the higher layer can be an application, session, transport, RRC, RLC, PDCP, or MAC layer. This procedure is as follows:
1. A candidate subframe, Rxy, is a set of contiguous sub-channels, x+j, in a subframe, t_m, where j=0, . . . , L−1, is a set of contiguous sub-channels within the time interval [n+T1, n+T2], the time stamp n is the packet arrival time. T1 and T2 are processing time and packet delay budget, respectively. T1 and T2 values depend on the UE implementation and should meet the following conditions:
   a. T1<=4 and T2_min (priority of TX)<=T2<=100, where the higher layer provides priority of TX, otherwise T2_min is set to 20.
2. A set of all candidate subframe resources is assumed in Sa, and an empty set of Sb is created.
3. The UE relocates a candidate subframe resource Rxy from set Sa into set Sb.
4. In case, a UE is configured by the higher layer to transmit on multiple carriers, the UE shall exclude a subframe resource Rxy from Sb, if the UE cannot support simultaneous transmission due to its limitation, or not support the corresponding carrier combination.
5. The UE shall send the Sb list to the higher layer.

With introduction of the sidelink in Rel-16 for NR, in autonomous resource selection, i.e., Mode 2, a V-UE has to perform sensing continuously to cater unoccupied radio resources in time and frequency domain for an arrived transport block such that the associated delay budget is met. Nowadays, an increasing number of devices using sidelink communications with limited battery life, e.g., pedestrian users, cyclists, electric cars, challenges the current sensing-based resource selection approach with respect of power efficiency of the radio resource selection procedure.

Therefore, there is the need for enhancements or improvements with respect to power efficiency in sidelink resource selection.

It is noted that the information in the above section is only for enhancing the understanding of the background of the invention and therefore it may contain information that does not form conventional technology and is already known to a person of ordinary skill in the art.

### SUMMARY

An embodiment may have a transceiver of a wireless communication system, wherein the transceiver is configured to operate in a sidelink in-coverage, out of coverage or partial coverage scenario, in which resources for a sidelink communication are allocated or scheduled autonomously by the transceiver, wherein the transceiver is configured to perform, for the sidelink communication, a random selection of resources out of a resource pool based on a quality of service, wherein the transceiver is configured to transmit a control information, the control information signaling at least one selected resource selected out of the resource pool by performing the random resource selection, wherein the control information is transmitted via a first stage sidelink control information, SCI, a second stage sidelink control information, SCI, or a higher layer.

According to another embodiment, a system may have: an inventive transceiver as mentioned above, and another transceiver, wherein the other transceiver is configured to determine an information describing the traffic and/or user density on the resource pool, and wherein the other transceiver is configured to transmit the information describing the traffic and/or user density on the resource pool to the transceiver.

According to another embodiment, a method for operating a transceiver may have the steps of: operating the transceiver in a sidelink in-coverage, out of coverage or partial coverage scenario, in which resources for a sidelink communication are allocated or scheduled autonomously by the transceiver, selecting, for the sidelink communication, a set of candidate resources out of a resource pool, wherein the set of candidate resources is selected randomly based on a quality of service, transmitting a control information, the control information signaling at least one selected resource selected out of the resource pool by performing the random resource selection, wherein the control information is transmitted via a first stage sidelink control information, SCI, a second stage sidelink control information, SCI, or a higher layer.

Another embodiment may have a non-transitory digital storage medium having stored thereon a computer program for performing a method for operating a transceiver, the method having the steps of: operating the transceiver in a sidelink in-coverage, out of coverage or partial coverage scenario, in which resources for a sidelink communication are allocated or scheduled autonomously by the transceiver, selecting, for the sidelink communication, a set of candidate resources out of a resource pool, wherein the set of candidate resources is selected randomly based on a quality of service, transmitting a control information, the control information signaling at least one selected resource selected out of the resource pool by performing the random resource selection, wherein the control information is transmitted via a first stage sidelink control information, SCI, a second stage sidelink control information, SCI, or a higher layer, when the computer program is run by a computer.

### BRIEF DESCRIPTION OF THE DRAWINGS

Embodiments of the present invention are described herein making reference to the appended drawings, in which:

FIGS. 1(a)-1(b) are schematic representations of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs, according to an embodiment;

FIG. 7 is a schematic representation of a selection process for selecting between a random selection of resources and a normal selection of resources, according to an embodiment; and

FIG. 8 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

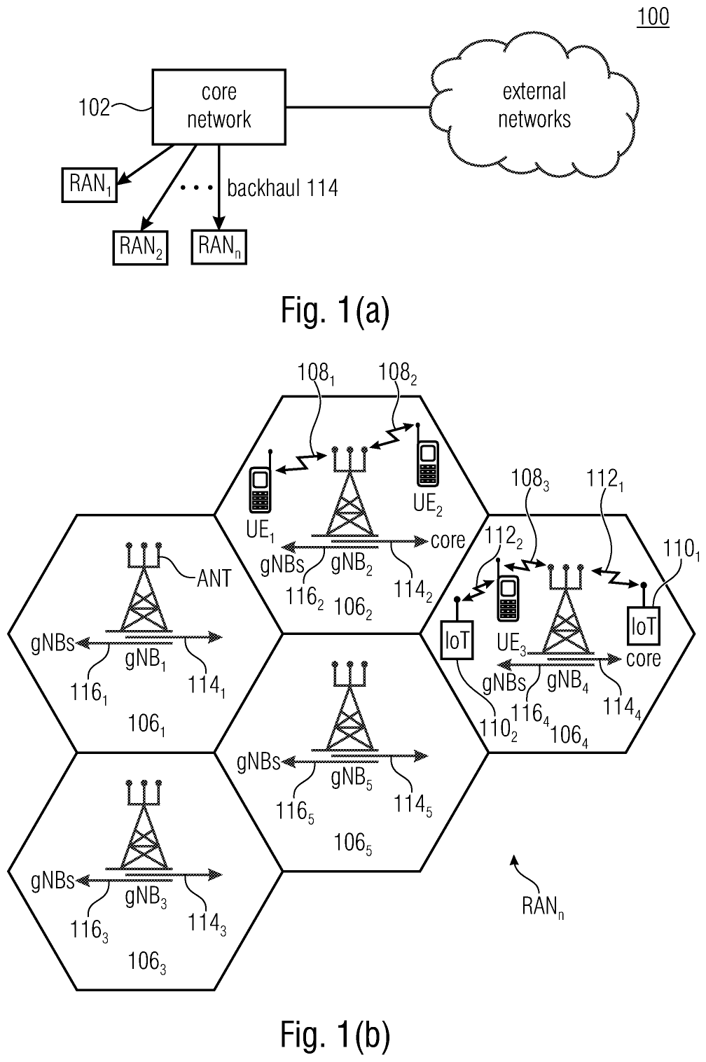

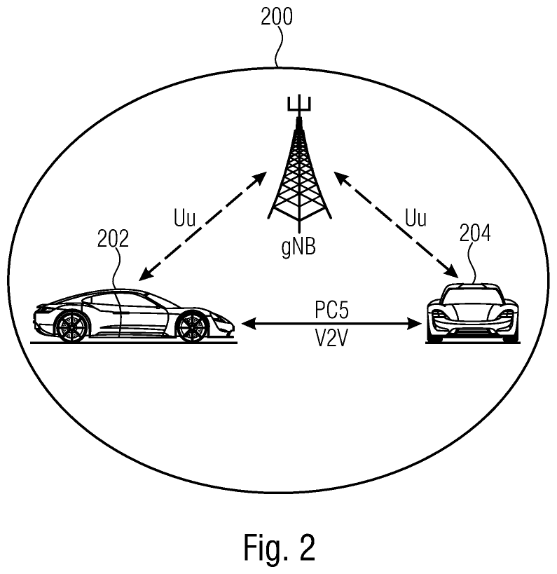

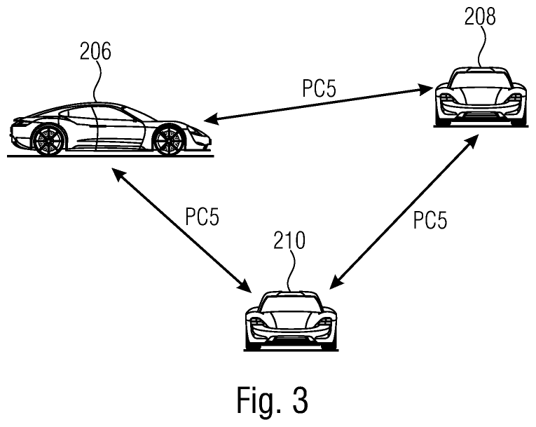

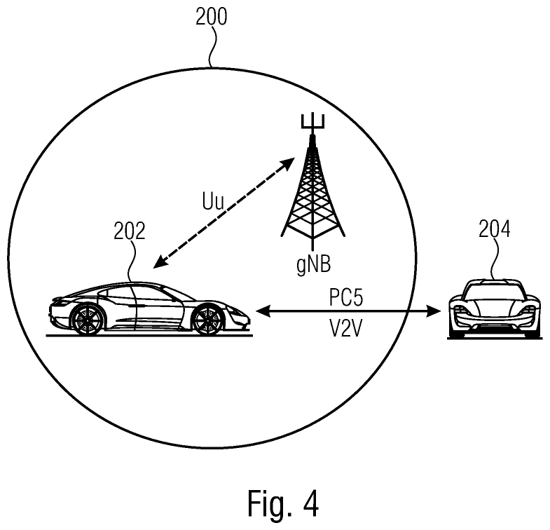

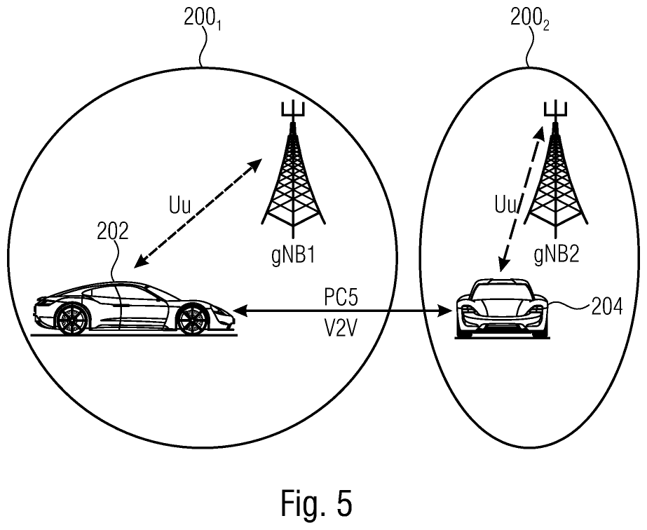

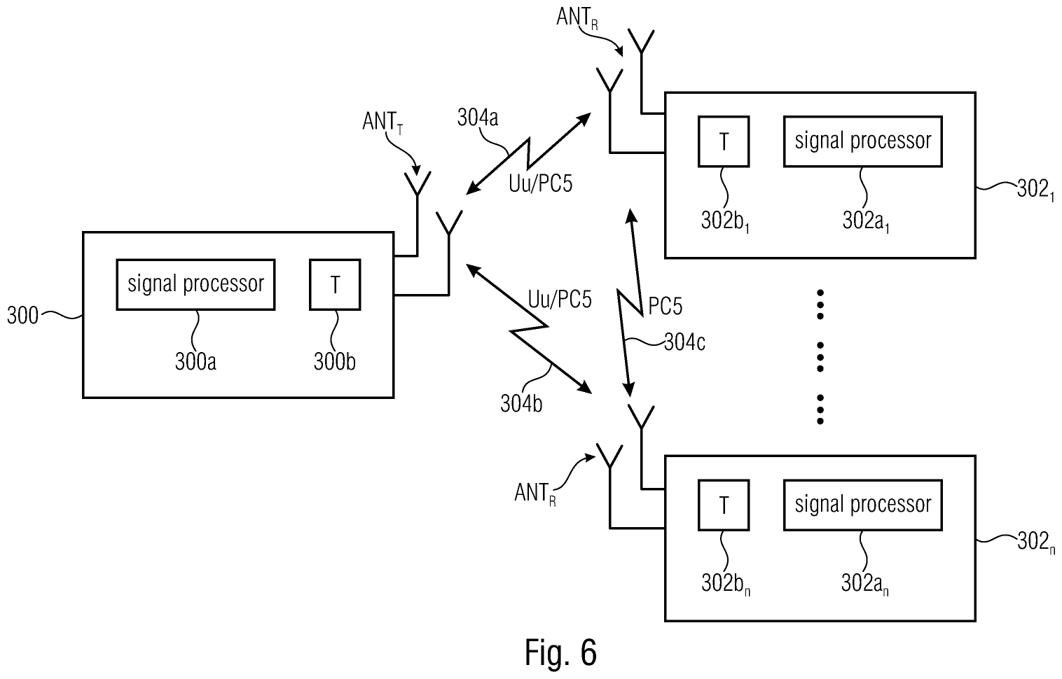

Embodiments of the present invention may be implemented in a wireless communication system as depicted in FIGS. 1-5 including base stations and users, like mobile terminals or IoT devices. FIG. 6 is a schematic representation of a wireless communication system including a central transceiver, like a base station, and one or more transceivers 3021 to 302n, like user devices, UEs. The central transceiver 300 and the transceivers 302 may communicate via one or more wireless communication links or channels 304a, 304b, 304c, like a radio link. The central transceiver 300 may include one or more antennas ANTT or an antenna array having a plurality of antenna elements, a signal processor 300a and a transceiver unit 300b, coupled with each other. The transceivers 302 include one or more antennas ANTR or an antenna array having a plurality of antennas, a signal processor 302a1, 302an, and a transceiver unit 302b1, 302bn coupled with each other. The base station 300 and the UEs 302 may communicate via respective first wireless communication links 304a and 304b, like a radio link using the Uu interface, while the UEs 302 may communicate with each other via a second wireless communication link 304c, like a radio link using the PC5 interface. When the UEs are not served by the base station, are not be connected to a base station, for example, they are not in an RRC connected state, or, more generally, when no SL resource allocation configuration or assistance is provided by a base station, the UEs may communicate with each other over the sidelink. The system, the one or more UEs and the base stations may operate in accordance with the inventive teachings described herein.

Embodiments provide a transceiver [e.g., UE] of a wireless communication system, wherein the transceiver is configured to operate in a [e.g., new radio, NR] sidelink in-coverage, out of coverage or partial coverage scenario [e.g., NR sidelink mode [e.g., mode 1 or mode 2]], in which resources for a sidelink communication [e.g., transmission and/or reception] are allocated or scheduled autonomously by the transceiver, wherein the transceiver is configured to perform, for the sidelink communication, a random selection of resources out of a resource pool based on
a traffic density and/or user density on the resource pool, and/or
a type of traffic on the resource pool, and/or
a quality of service [e.g., of data to be transmitted by the transceiver; or of a data type].

In embodiments, the transceiver is configured to determine [e.g., compute] the traffic density and/or user density in dependence on at least one out of an aperiodic traffic and periodic traffic within the resource pool.

In embodiments, the transceiver is configured to perform the random selection of resources if the traffic and/or user density on the resource pool fulfills a certain or pre-defined condition.

In embodiments, the certain or pre-defined condition is fulfilled if the traffic and/or user density on the resource pool or a measurement value [e.g., CBR value] describing the same is smaller than a predefined threshold.

In embodiments, the traffic density or user density corresponds with a specific priority threshold, range of priority levels, or any other metrics [for example quality of service].

In embodiments, the transceiver is configured to perform a normal selection of resources if the traffic and/or user density on the resource pool does not fulfill the certain or pre-defined condition.

In embodiments, the transceiver is configured to perform the sidelink communication using one or more of the selected resources.

In embodiments, the resource pool is a common resource pool [e.g., used for different traffic and/or cast types].

In embodiments, the resource pool corresponds to a traffic type with a specific priority or a range of priority level.

In embodiments, the resource pool is a traffic type specific resource pool.

In embodiments, the resource pool is an aperiodic or periodic traffic only resource pool.

In embodiments, the resource pool is a dedicated resource pool or an exceptional resource pool.

In embodiments, at least a part of the resource pool is dedicated to users with traffic with a specific priority or priority level or quality of service.

In embodiments, the transceiver is configured to determine an information [e.g., measurement value] describing the traffic and/or user density on the resource pool itself.

In embodiments, the transceiver is a UE.

In embodiments, the UE is a vulnerable UE.

In embodiments, the transceiver is battery operated.

In embodiments, the transceiver is configured to transmit a control information, the control information signaling at least one selected resource selected out of the resource pool by performing the random resource selection.

In embodiments, the control information is transmitted via a first stage sidelink control information, SCI, a second stage sidelink control information, SCI, or a higher layer [e.g., MAC CE or RRC].

In embodiments, the control information comprises at least one out of a priority or priority range corresponding to the traffic density or user density of the at least one selected resource.

In embodiments, the transceiver is configured to trigger the random selection of resources within the resource pool [e.g., dedicated resource pool or exceptional resource pool] based on the traffic density or user density of the resource pool or based on a configured priority of the resource pool.

In embodiments, the transceiver is configured to perform the random selection of resources of the resource pool using a sensing window, wherein a number of candidate resources defined by the sensing window is below a configured threshold.

In embodiments, the transceiver is configured to trigger the random selection in order to provide a minimum amount of radio resources entailed for a specific quality of service.

In embodiments, the other transceiver is configured to determine information describing a priority or range of priority level corresponding to a traffic and/or user density on a resource pool [e.g., indicated in the 1^{st} SCI or 2^{nd} SCI or the higher layer signaling, for example, by MAC CE or RRC], wherein the other transceivers is configured to preempt its resources and trigger another resource selection.

Further embodiments provide a method for operating a transceiver. The method comprises a step of operating the transceiver in a [e.g., new radio, NR] sidelink in-coverage, out of coverage or partial coverage scenario [e.g., NR sidelink mode [e.g., mode 1 or mode 2]], in which resources for a sidelink communication [e.g., transmission and/or reception] are allocated or scheduled autonomously by the transceiver. Further, the method comprises a step of performing, for the sidelink communication, a random selection of resources out of a resource pool based on
a traffic density and/or user density on the resource pool, and/or
a type of traffic on the resource pool, and/or
a quality of service.

Embodiments provide partial sensing based RA as a power saving RA scheme.

Embodiments provide random resource selection as a power saving RA scheme.

Embodiments provide a resource selection strategy based on different condition triggering random resource selection, to maximize the energy efficiency of a device with limited battery power.

Embodiments described herein provide different resource selection concepts for NR V2X Mode2, which allow for at least one out of (1) reducing the UE power consumption, (2) at least partially increasing the capacity and reliability, and (3) reducing the latency. Embodiments described herein may be applied advantageously to UEs with limited battery capacity, e.g., P-UEs, but may also apply to all other types of UEs, e.g., cyclist, e-Bike, e-Car or V-UE in general.

In embodiments, the random selection can be seen as a viable solution to save power as the sensing procedure is avoided. However, it causes collision if the selected resources are used by other nearby transceivers (e.g., UEs). To resolve this problem, in accordance with embodiments, a transceiver (e.g., UE) can be configured to adopt its radio resource selection strategy, i.e., random resource selection, to reduce power consumption considering network conditions, such as, for example,
specific traffic type, periodic and aperiodic load constraints, channel load (e.g., CBR), QoS (e.g., of data, data types or (e.g., types of) messages),

wherein a transceiver (e.g., UE) can adopt at least one of the following strategies to reduce power consumption:
random selection of radio resources for aperiodic or periodic traffic in a, e.g., shared resource pool (cf. section 1); and
random resource selection based on resource pools configured for defined traffic types, e.g., aperiodic or periodic traffic (cf. section 2).

In embodiments, the parameters and random selection procedure described above could be configured, for example, by the higher layer signaling through RRC or DCI configuration.

Subsequently, embodiments are described in further detail.

### 1. Random Resource Selection for Periodic or Aperiodic Traffic Based on Traffic/User Density on a Shared Resource Pool

In embodiments, a UE can be configured to decide (or determine) to perform random resource selection from a resource pool, e.g., shared resource pool, based on measurements. For example, the UE may use a metric, such as, for example, a CBR measurement, wherein random selection is performed when the metric is below a specific threshold, for example, configured by higher layer signaling, otherwise the UE performs regular sensing or partial sensing.

For example, if the CBR is low (e.g., indicating low load), e.g., below a (pre-)defined threshold, random resource selection can be performed on a resource pool, such as a shared resource pool or exceptional resource pool. Thereby, the threshold can be configured, for example, by higher layer signaling, e.g., RRC or DCI.

For example, if the if the CBR is high (e.g., indicating high load), e.g., equal to or above a (pre-)defined threshold, normal resource selection (e.g. partial sensing) can be performed on the resource pool.

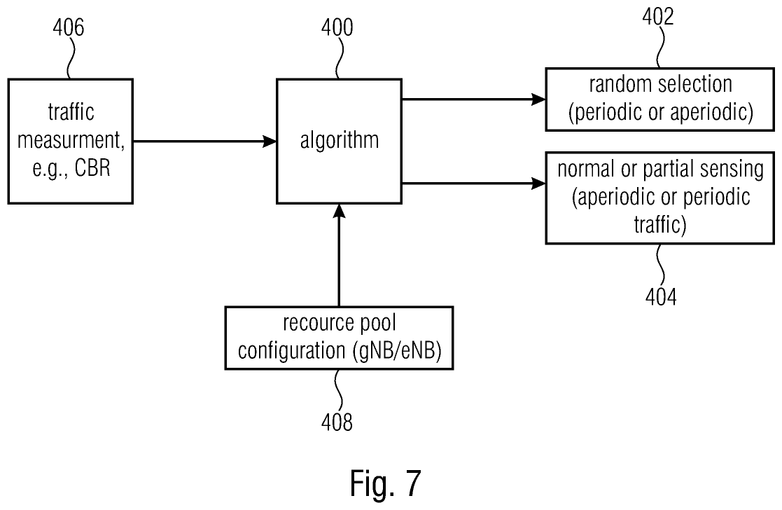

FIG. 7 shows the concept of the idea, as explained above.

In detail, FIG. 7 shows a schematic representation of a selection process 400 (e.g., performed by a transceiver, e.g., UE) for selecting between a random 402 selection of resources and a normal 404 selection of resources. As indicated in FIG. 7, the process 400, e.g., implemented as an algorithm in FIG. 7, can be configured to select between the random 402 selection of resources and the normal 404 selection of resources in dependence on information 406 describing a condition (or status) of the resource pool, such as traffic density, user density or any other measurement (e.g., CBR). For example, the process 400 can be configured to select the random 402 selection of resources if the condition fulfills a predefined condition, such as, for example, if traffic density, user density, or measurement value falls below a predefined threshold, and to select the normal 404 selection of resources else. Further, as indicated in FIG. 7, the process 400 may receive a resource pool configuration 408, e.g., from a gNB or eNB.

In other words, FIG. 7 shows an illustrative example of a resource selection mechanism based on traffic density.

### 2. Random Resource Selection on a Traffic Specific (Pre-)Configured Resource Pool

In embodiments, a transceiver (e.g., UE) can be configured to perform random radio resource selection on a defined resource pool or multiple defined resource pools configured for a specific traffic type, such as, for example, aperiodic traffic. In general, resource pools may be configured for periodic or aperiodic traffic, wherein resource allocation using random selection may be performed in resource pool(s) configured/setup for aperiodic traffic only. This way, collision with resource allocation for period traffic may be avoided. This would result in improved latency and reliability and/or in increased throughput.

In embodiments the resource pool configuration and random selection can be chosen (or decided) based on the measurement, and be (pre-) configured by RRC or any higher layer signaling message.

### 3. Algorithm—Traffic Based Resource Selection with Resource Segregation

Embodiments provide a combination of splitting resource pools along with different scheduling mechanism based on traffic type.

Specifically, in embodiments a resource selection mechanism is provided, where the resource pool can be split in the frequency domain for different traffic types, and where the different scheduling mechanisms for periodic and aperiodic messages can be used, or vice versa. For example, the resource pool can be split in the frequency domain based on traffic density of the periodic and aperiodic messages, where the periodic traffic performs sensing-based resource allocation and the aperiodic traffic performs random based resource allocation.

Subsequently, an exemplary algorithm (pseudo code) is provided which allows for splitting a resource pool, RP, along with different scheduling mechanisms based on traffic type:
Set X=% of periodic traffic
Set Y=% of aperiodic traffic
for splitting resource pool in frequency domain do
   X % of RP for periodic traffic
   Y % of RP for aperiodic traffic
end for
scheduling Mechanism
Get full Resource Pools
if Traffic type=periodic then Scheduling=Sensing % only for X percentage of resource pools %
else Scheduling=Random % only for Y percentage of resource pools %
end if

To summarize, according to the algorithm, a resource pool can be slit in the frequency domain and different scheduling types can be applied based on the traffic type. For example, if the periodic traffic is smaller than X % in the resource pool, then sensing based resource selection can be applied. If the aperiodic traffic is smaller than Y % in the resource pool, then random resource selection can be applied.

### 4. Results and Observations for the Algorithm of Section 3

Subsequently, results and observations of the algorithm of section 3 are described, according to which the resource pool is split in the frequency domain and different resource selection mechanisms are performed based on different types of traffic.

Simulations show that the packet reception ration, PRR, is close and similar to the 5G NR fully sensing based scheduling (baseline). Thus, the performed random scheduling for aperiodic traffic and sensing based scheduling for the periodic traffic provides high reliability to aperiodic traffic compared to the baseline and also helps in the conservation of the devices power, since aperiodic traffic does not perform channel sensing.

Further, simulations show that the fully random based scheduling provides low latency compared to the sensing-based scheduling in 5G NR. Hence, the algorithm of section 3 provides high reliability and low latency for the 5G NR V2X communications. This is because, the splitting of the resource pools helps is fewer collisions between the periodic SCIs and aperiodic SCIs, where the aperiodic traffic exhibits high reliability compared to periodic traffic since there is no reservation of future sub channels for aperiodic traffic. Hence, fewer sub channels are occupied for aperiodic traffic compared to periodic traffic. Similarly, to provide reliability to the periodic traffic, a channel sensing mechanism is used, where for aperiodic traffic the random allocation of the resources is sufficient, so the overall PIR is low compared to the baseline, providing low latency and high reliability to aperiodic traffic applications.

Hence the algorithm of section 3, i.e., splitting of a resource pool, RP, in frequency domain along with different scheduling mechanism for different traffic type provides the following advantages:
The PRR significantly improves, providing high reliability mainly for aperiodic traffic.
The PIR reduces, providing low latency compared to the baseline fully sensing-based scheduling in 5G NR.

### 5. Further Embodiments

Vehicle-to-Everything (V2X) communication enables vehicles, pedestrian users, and infrastructure facilities to communicate together. The autonomous communications between two user's equipment (UEs) without a direct signal from the base station, happens through 3GPP sidelink transmissions, which have been used mostly for public safety and vehicle-to-everything (V2X) services. The evolution of sidelink transmissions from LTE-A (Long-Term-Evolution Advanced) continues in 3GPP New Radio (NR), which targets at offering low latency, high reliability, and high throughout V2X services for advanced driving use cases.

Safety-related communications can be periodic and aperiodic messages, which entail high reliability and low latency service. To provide such services between users directly, i.e., in an autonomous situation without the help of any cellular infrastructure, a proper resource sharing mechanism had to be incorporated. The 5G NR uses a sensing-based mechanism, that has been developed based on LTE, which senses the channel for free resources, where it predicts the resources occupied in the future based on the previous data and then sends the messages, similar to Listen-Before-Talk (LBT). However, this mechanism degrades the power consumption of the UEs. Since a major part of the device's power is used for sensing the channel. Hence it is not helpful for devices that depend on power usage (e.g., pedestrian users).

Hence, embodiments provide a resource sharing mechanism. Also, the present 3GPP standards do not provide a separate QoS (Quality-of-Service) based on the data types, especially based on periodic and aperiodic messages. Here, aperiodic messages are given more importance than periodic messages, due to its service mainly for public safety messages, and addressing this problem to provide high reliability and low latency mainly for aperiodic messages.

In embodiments, for random resource selection in a resource pool (pre-)configured with full/partial sensing and random resource selection, down-selection to one of the followings options can be performed.

According to a first option, a priority threshold value or a range of priority levels can be (pre-) configured for the resource pool, below or within which random resource selection is allowed. Thereby, lower value means higher priority. In embodiments, resource pool partitioning can be additionally applied.

According to a second option, the priority for the transmission can be increased based on random selection, wherein the new priority value can be indicated, for example, in the priority field in the 1st-stage SCI. In embodiments, an extra field can be added in SCI for indicating the original priority value associated with QoS requirement. In embodiments, a 1-bit field in the SCI may indicate that the UE is performing random resource selection. In embodiments, an extra field can be added in SCI for indicating the mapping to the original priority value associated with QoS requirement.

According to a third option, resources reserved by UE performing random selection without re-evaluation/pre-emption checking can be excluded, regardless of their priorities. E.g. a 1-bit field in the SCI may indicate that the UE is performing random resource selection and not performing re-evaluation and pre-emption checking.

In embodiments, for random resource selection, the maximum distance separation of 32 logical slots for a HARQ retransmission resource reserved by a prior SCI for the same TB can be reused, which was defined in R16 for full sensing operation.

In embodiments, for random resource selection, a SL HARQ feedback enabled transmission is supported. Thereby, the minimum HARQ feedback time gap (Z) can be respected between any two selected resources of a TB where a HARQ feedback for the first of these resources is expected.

In embodiments, the impact of resource collision when random resource selection can be performed by a UE which does not perform sensing/re-evaluation and pre-emption checking in a resource pool with mixed RA schemes (e.g. for low priority or any priority transmissions).

In embodiments, re-evaluation and pre-emption checking are not supported by UEs that do not perform any sensing (i.e. PSCCH reception).

In embodiments, re-evaluation and pre-emption checking are supported by UEs that perform sensing.

In embodiments, when a UE performs at least contiguous partial sensing in a mode 2 Tx pool for a resource (re)selection procedure triggered by aperiodic transmission (Prsvp_TX=0) in slot n, the UE selects a set of Y′ candidate slots with corresponding PBPS and/or CPS results (if available) within the RSW. If the total number of Y′ candidate slots is less than a (pre-)configured threshold Y′min, then (1) the UE may select other candidate slots within the RSW until Y′=Y′min and/or (2) the UE performs random resource selection in an exceptional pool.

In embodiments, when UE performs random resource selection, a (rep-)configured value can be used for SL CBR measurement.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

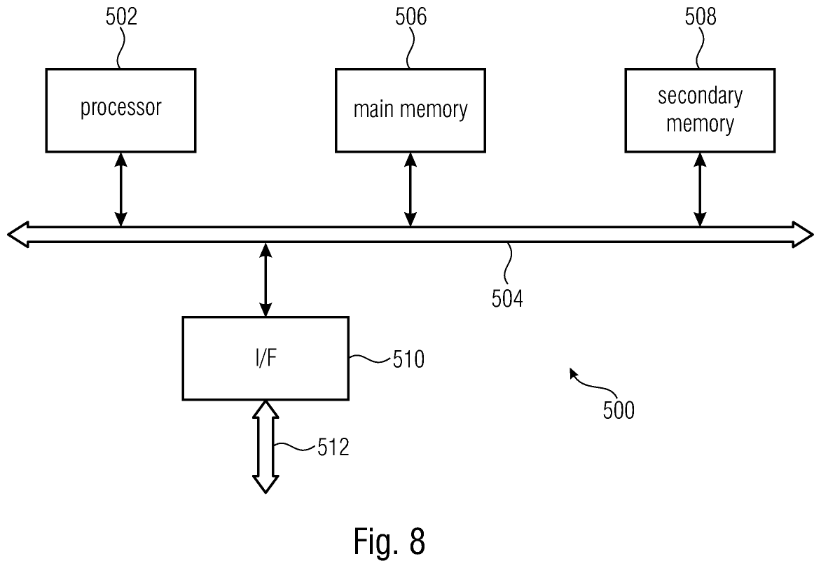

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 8 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] 36.213 V15.8.0 (2019-12)
[2] 38.214
[3] 3GPP RP-19322, Work Item Description, NR Sidelink enhancements, Rel-17

1. A transceiver of a wireless communication system,
wherein the transceiver is configured to operate in a sidelink in-coverage, out of coverage or partial coverage scenario, in which resources for a sidelink communication are allocated or scheduled autonomously by the transceiver,
wherein the transceiver is configured to perform, for the sidelink communication, a random selection of resources out of a resource pool based on
a quality of service,
wherein the transceiver is configured to transmit a control information, the control information signaling at least one selected resource selected out of the resource pool by performing the random resource selection,
wherein the control information is transmitted via a first stage sidelink control information, SCI, a second stage sidelink control information, SCI, or a higher layer.

2. The transceiver according to claim 1,
wherein the transceiver is configured to determine the traffic density and/or user density in dependence on at least one out of an aperiodic traffic and periodic traffic within the resource pool.

3. The transceiver according to claim 1,
wherein the transceiver is configured to perform the random selection of resources if the traffic and/or user density on the resource pool fulfills a certain or pre-defined condition.

4. The transceiver according to claim 3,
wherein the certain or pre-defined condition is fulfilled if the traffic and/or user density on the resource pool or a measurement value describing the same is smaller than a predefined threshold,
and/or wherein the traffic density or user density corresponds with a specific priority threshold, range of priority levels, or any other metrics,
and/or wherein the transceiver is configured to perform a normal selection of resources if the traffic and/or user density on the resource pool does not fulfill the certain or pre-defined condition.

5. The transceiver according to claim 1,
wherein the transceiver is configured to perform the sidelink communication using one or more of the selected resources.

6. The transceiver according to claim 1,
wherein the resource pool is a traffic type specific resource pool, or
wherein the resource pool corresponds to a traffic type with a specific priority or a range of priority level.

7. The transceiver according to the claim 6,
wherein the resource pool is a aperiodic or periodic traffic only resource pool.

8. The transceiver according to claim 6,
wherein the resource pool is a dedicated resource pool or an exceptional resource pool.

9. The transceiver according to claim 7,
wherein at least a part of the resource pool is dedicated to users with traffic with a specific priority or priority level or quality of service.

10. The transceiver according to claim 1,
wherein the transceiver is configured to determine an information describing the traffic and/or user density on the resource pool itself.

11. The transceiver according to claim 1,
wherein the transceiver is a UE.

12. The transceiver according to claim 11,
wherein the UE is a vulnerable UE.

13. The transceiver according to claim 1,
wherein the transceiver is battery operated.

14. The transceiver according to claim 1,
wherein the control information comprises at least one out of a priority or priority range corresponding to the traffic density or user density of the at least one selected resource.

15. The transceiver according to claim 1,
wherein the transceiver is configured to trigger the random selection of resources within the resource pool based on the traffic density or user density of the resource pool or based on a configured priority of the resource pool.

16. The transceiver according to claim 1,
wherein the transceiver is configured to perform the random selection of resources of the resource pool using a sensing window, wherein a number of candidate resources defined by the sensing window is below a configured threshold.

17. The transceiver according to claim 16,
wherein the transceiver is configured to trigger the random selection in order to provide a minimum amount of radio resources required for a specific quality of service.

18. A system, comprising:
a transceiver according to claim 1, and
another transceiver,
wherein the other transceiver is configured to determine an information describing the traffic and/or user density on the resource pool,
and wherein the other transceiver is configured to transmit the information describing the traffic and/or user density on the resource pool to the transceiver.

19. A method for operating a transceiver, the method comprising:
operating the transceiver in a sidelink in-coverage, out of coverage or partial coverage scenario, in which resources for a sidelink communication are allocated or scheduled autonomously by the transceiver,
selecting, for the sidelink communication, a set of candidate resources out of a resource pool,
wherein the set of candidate resources is selected randomly based on
a quality of service,
transmitting a control information, the control information signaling at least one selected resource selected out of the resource pool by performing the random resource selection,
wherein the control information is transmitted via a first stage sidelink control information, SCI, a second stage sidelink control information, SCI, or a higher layer.

20. A non-transitory digital storage medium having stored thereon a computer program for performing a method for operating a transceiver, the method comprising:
operating the transceiver in a sidelink in-coverage, out of coverage or partial coverage scenario, in which resources for a sidelink communication are allocated or scheduled autonomously by the transceiver,
selecting, for the sidelink communication, a set of candidate resources out of a resource pool,
wherein the set of candidate resources is selected randomly based on
a quality of service,
transmitting a control information, the control information signaling at least one selected resource selected out of the resource pool by performing the random resource selection,
wherein the control information is transmitted via a first stage sidelink control information, SCI, a second stage sidelink control information, SCI, or a higher layer,
when the computer program is run by a computer.
